(19) United States
(12) Patent Application Publication
(10) Pub. No.: US 2025/0291354 A1
(43) Pub. Date: Sep. 18, 2025

(54) CENTROIDAL RATE ESTIMATION FOR ROBOTIC LOCOMOTION

(71) Applicants: Robert Griffin, Pensacola, FL (US); Yu-Ming Chen, Pensacola, FL (US)

(72) Inventors: Robert Griffin, Pensacola, FL (US); Yu-Ming Chen, Pensacola, FL (US)

(21) Appl. No.: 19/073,507

(22) Filed: Mar. 7, 2025

Related U.S. Application Data
(60) Provisional application No. 63/565,047, filed on Mar. 14, 2024.

(51) Int. Cl. G05D 1/495; B62D 57/032; G05D 109/12

(52) U.S. Cl. CPC G05D 1/495; B62D 57/032; G05D 2109/12

(57) ABSTRACT

A system and method for providing a position and rate of change for a robot that is useful in a robotic control system. The invention uses an inverted pendulum and flywheel model. The model produces a linear momentum parameter and an angular momentum parameter. The inventors have developed a modified velocity measure for the control system that combines both the linear and angular rates of motion for the robot into an equivalent linear rate. This equivalent linear rate captured the same dynamic effects as using both a linear and angular rate does for the prior art systems. The developed equivalent linear rate can be used for a number of purposes, including feedback control during walking, step placement, planning, and measurement of balance conditions.

### CROSS-REFERENCES TO RELATED APPLICATIONS

This non-provisional patent application claims priority to Provisional Application Ser. No. 63/565,047. The provisional application was filed on Mar. 14, 2024. It listed the same inventors.

### STATEMENT REGARDING FEDERALLY SPONSORED RESEARCH OR DEVELOPMENT

Not Applicable

### BACKGROUND OF THE INVENTION

### 1. Field of the Invention

The present invention pertains to the field of robotics. More specifically, the invention comprises an improved system for controlling motion in a legged robot—such as a humanoid robot.

### 2. Description of the Related Art

FIG. 1 depicts a prior art humanoid robot 10. The robot is shown in a walking motion. The right leg contacts surface 12 at contact point 14. Software running on a processor is used to govern the motion of such a robot. FIG. 4 provides a very simplified depiction of an exemplary robot motion control system 26. Processor 28 loads control software from its associated memory 30. The control software receives information from numerous sensors 32-38. The suite of sensors typically include linear accelerometers, attitude sensors, attitude rate sensors, contact force sensors, etc. In this example, suitable input/output ports are used to interface the processor with the sensors.

The processor runs complex control functions to generate output parameters. These output parameters are generally fed to multiple output drivers 40,42. The output drivers greatly amplify the control signals (and in many cases modify them as well) to provide driving signals to actuators 44-52. The actuators control the various degrees of freedom the robot possesses. The control scheme shown is a closed-loop scheme.

The actual control functions implemented by the software running on the processor assume many widely-varying forms. However, some operative control parameters are useful across many different control schemes. As an example, in order to stabilize walking motions for humanoid robots, it is common to provide the control system information concerning the position and rate of change of the robot state. A goal of the control system is to keep the robot in a desired configuration, and to keep the robot moving at the correct rate in that configuration.

With existing sensor technology it is possible to monitor many aspects of the robot's state in near-real-time. However, it is often helpful to use a simplified model to drive the control system. The simplified model is able to provide enough information to regulate balance and motion without unduly burdening the processor.

One such known simplified model considers the robot as an inverted pendulum with a single point of ground contact. FIG. 2 illustrates this approach. Returning briefly to FIG. 1, the reader will observe that humanoid robot 10 has the right leg in contact with the ground at contact point 14 (point “p”). FIG. 2 shows the simplified inverted pendulum model of this motion. The entire mass of the robot is considered as a point mass located on center of mass 16. The right leg and the left leg (The left leg is at this point in time the swing leg) are considered mass-less in this approach. The moving robot possesses linear momentum 20. The control scheme considers the robot as an inverted pendulum having linear momentum 20 (pivoting over contact point 14). This information can be used to determine a position for the next step made by the robot in order to achieve a desired state (such as continued stable walking or bringing the robot to a balanced halt).

A pendulum is balanced if it is vertical and not moving (To be complete it is worth noting that a pendulum can be balanced while moving vertically). If it is moving horizontally while vertical, it will not remain stable. Often, the robotic control system simplifies the position and rate of the robot to the position and velocity of the center of mass. This, however, is a limited simplification as it ignores the rotational state of the system.

A goal of humanoid robot design is the mimicking of normal human motion—including bipedal walking. Actual human beings do not hold the torso motionless while walking. Instead, humans tend to bend the torso about the hip joints in order to achieve balance and motion goals. This is an effective human strategy and one that is beneficial to humanoid robots. In order to take advantage of this additional degree of freedom, it is useful to have humanoid robots undertake the same motion. (The swinging of the legs when taking a step generated angular momentum as well. In many instances it will be worth considering this angular momentum of the legs and not just the motion of the torso.)

A modified inverted pendulum model accommodating the movement of the torso can be useful in robotic control systems. FIG. 2 shows a modification of the prior art linear inverted pendulum model. The modified model includes a flywheel 18. The flywheel is modeled as a rotating mass that is allowed to rotate within fixed angular limits. The presence of the flywheel allows the modeling of rotation in addition to linear motion. The result is a modeling of angular momentum 22 in addition to linear momentum 20. This allows a more accurate—but still suitably simplified—model of the robot.

However, it takes the processing from one in which a single parameter is used (a linear momentum vector) to one in which two parameters are used (a linear momentum vector and an angular momentum vector). The reader should also bear in mind that FIG. 2 is a 2-dimensional depiction. The actual vectors will exist in three-dimensional space. The addition of the flywheel model thus introduces substantial complexity. It is desirable to obtain the advantages of the flywheel model while minimizing the added complexity. The present invention does this.

### BRIEF SUMMARY OF THE INVENTION

The present invention comprises a system and method for providing a position and rate of change for a robot that is useful in a robotic control system. The invention uses an inverted pendulum and flywheel model. The model produces a linear momentum parameter and an angular momentum parameter. The inventors have developed a modified velocity measure for the control system that combines both the linear and angular rates of motion for the robot into an equivalent linear rate. This equivalent linear rate captures the same dynamic effects as using both a linear and angular rate in the prior art systems. The developed equivalent linear rate can be used for a number of purposes, including feedback control during walking, step placement, planning, and measurement of balance conditions.

### BRIEF DESCRIPTION OF THE SEVERAL VIEWS OF THE DRAWINGS

FIG. 1 is an elevation view, showing a humanoid robot walking.

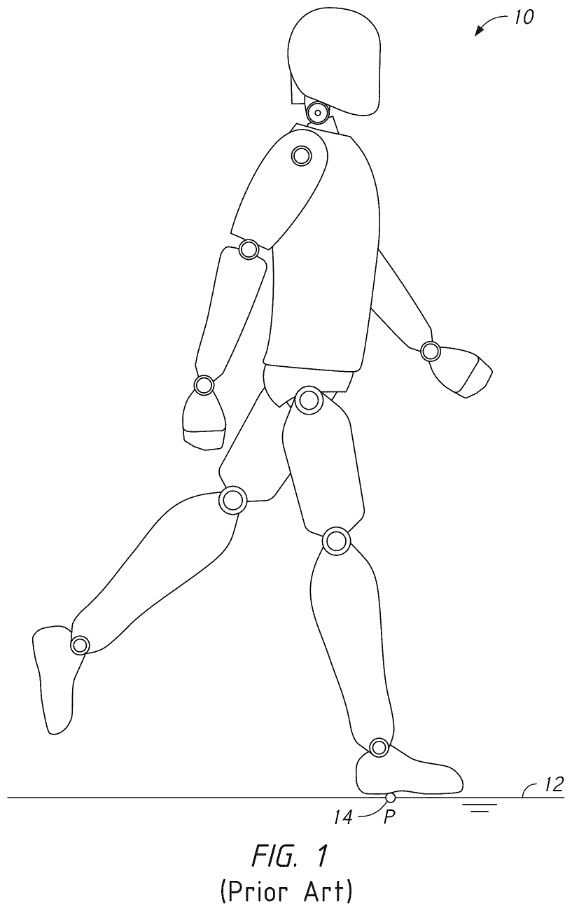

FIG. 2 is a graphical view, depicting an inverted pendulum model.

FIG. 3 is a graphical view, depicting an equivalent linear momentum vector as contemplated in the present invention.

FIG. 4 is a block diagram depicting the components of an exemplary robotic control system.

### REFERENCE NUMERALS USED IN THE DRAWINGS

10 humanoid robot
12 surface
14 contact point
16 center of mass
18 flywheel
20 linear momentum
22 angular momentum
24 equivalent linear momentum
26 motion control system
28 processor
30 memory
32 sensor
34 sensor
36 sensor
38 sensor
40 output driver
42 output driver
44 actuator
46 actuator
48 actuator
50 actuator
52 actuator

### DETAILED DESCRIPTION OF THE INVENTION

The inventors have developed a modified velocity measure for a robotic control system that combines both the linear and angular rates of motion. The derived equivalent rate can be used for a number of purposes, including feedback control during walking, step placement, planning, and measurement of balance conditions.

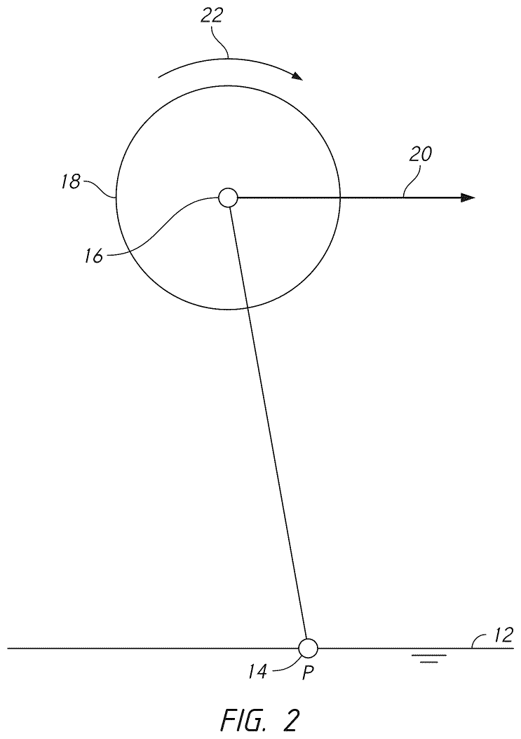

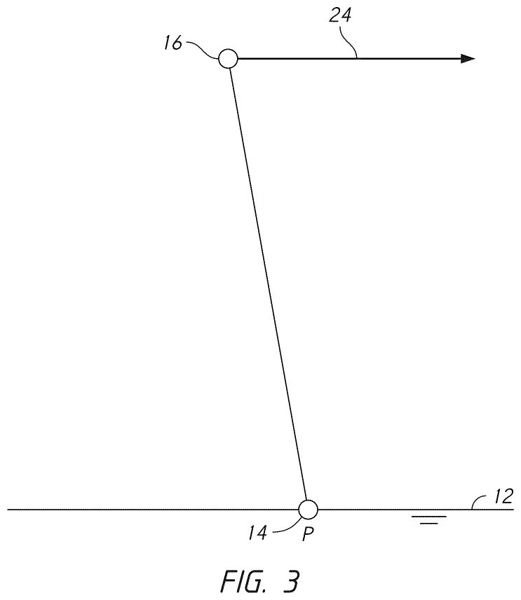

FIGS. 2 and 3 show the derivation of this improved and equivalent rate estimate for a walking system using the linear and angular momentum and center of mass position. In the depiction of FIG. 2, a linear momentum vector and an angular momentum vector are determined for the modified inverted pendulum model (including the flywheel model to represent angular momentum). In the depiction of FIG. 3, an equivalent linear momentum vector 24 is created to capture the same dynamic effects as the model of FIG. 2.

The total angular momentum at contact point 14 (point “p”) for the scenario of FIG. 2 is determined by the following equation:

$${L}_{p} = ( {r}_{c o m} - p ) * m v + {L}_{c o m}$$

Here the term (r_{com}−p) is the length from the center of mass to the contact point, mv is the linear momentum of the robot taken at the center of mass, and L_{com} is the angular momentum of the robot taken at the center of mass. The desire is to determine an equivalent \hat{ν}—the equivalent velocity that captures the angular and linear states in a single measure. This value can be derived as follows:

$${L}_{p} = ( {r}_{com} - p ) * m \hat{v} = ( {r}_{com} - p ) \times m v + {L}_{com}$$

$$\hat{v} = \frac{( {r}_{com} - p ) ⋆ mv}{( {r}_{com} - p ) ⋆ m} + \frac{{L}_{c o m}}{( {r}_{com} - p ) ⋆ m}$$

$$\hat{v} = v + \frac{{L}_{c o m}}{( {r}_{c o m} - p ) * m}$$

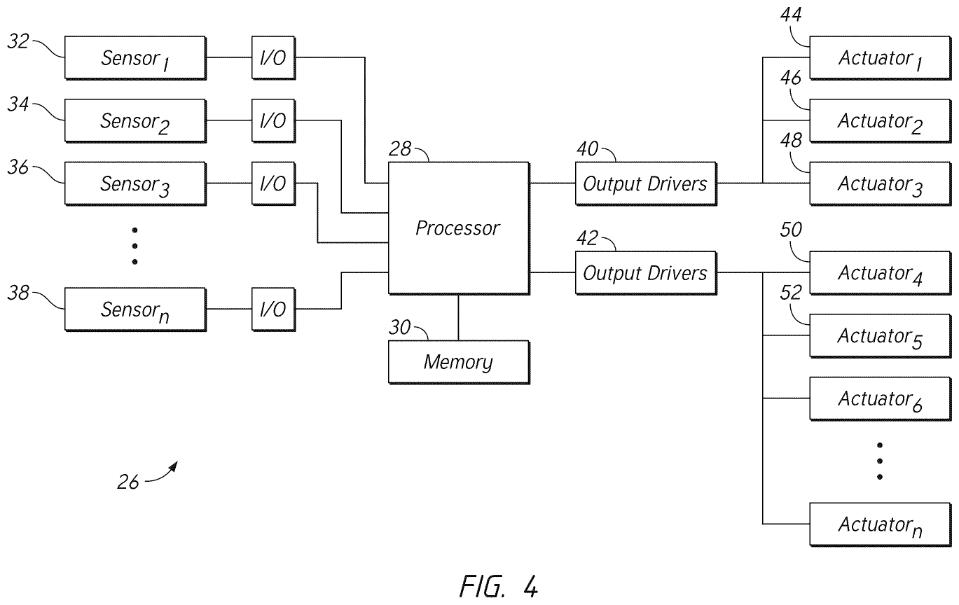

This equivalent linear momentum (shown in FIG. 3 as equivalent linear momentum 24) is thus equivalent to the net momentum (linear and angular) shown in FIG. 2. This improved rate estimate can then be used in a robotic balance controller such as depicted in FIG. 4.

The value for equivalent velocity can be used to improve feedback control using known strategies implemented in the control system—such as the ankle strategy, which seeks to compute a necessary center of pressure to stabilize the system based on the dynamic state. As this state typically includes some velocity measurement of the system, this approach can be improved using this equivalent improved rate estimate.

The use of the equivalent velocity (and equivalent momentum) is also useful for a robotic control system in determining where to step, such as the capture region. This uses a combination of the center of mass position and velocity, but ignores the angular state. By using the improved rate measurement, the capture region can correspondingly be improved.

Having described our invention, we claim:

1. A method for controlling a humanoid robot, said humanoid robot having a control system implemented via software running on a processor, a plurality of sensors providing information to said control system, and a plurality of actuators applying control forces, said robot engaged in a walking motion with a contact point p, said method for control comprising:
(a) said control system determining an angular momentum, L_{com}, for said robot taken at a center of mass for said robot;
(b) said control system determining an equivalent velocity parameter, \hat{ν}, that captures said robot's angular and linear states in a single measure, said equivalent velocity parameter being determined by an expression
$$\hat{v} = v + \frac{{L}_{c o m}}{( {r}_{c o m} - p ) * m} ,$$
where (r_{com}−p) is a length from said center of mass to said contact point and m is a mass of said robot; and
(c) said control system using said equivalent velocity parameter as part of feedback control.

2. A method for controlling a humanoid robot as recited in claim 1 wherein said control system determines said angular momentum using a flywheel model comprising a rotating mass allowed to rotate within fixed angular limits.

3. A method for controlling a humanoid robot as recited in claim 1 wherein said control system uses said equivalent velocity parameter in determining where said robot should step.

4. A method for controlling a humanoid robot as recited in claim 2 wherein said control system uses said equivalent velocity parameter in determining where said robot should step.

5. A method for controlling a humanoid robot as recited in claim 1 wherein said control system uses said equivalent velocity parameter in determining a necessary center of pressure to stabilize said robot.

6. A method for controlling a humanoid robot, said humanoid robot having a control system implemented via software running on a processor, a plurality of sensors providing information to said control system, and a plurality of actuators applying control forces, said robot engaged in a walking motion with a contact point p, said method for control comprising:
(a) said control system determining an angular momentum, L_{com}, for said robot taken at a center of mass for said robot;
(b) said control system determining an equivalent velocity parameter, \hat{ν}, that captures said robot's angular and linear states in a single measure, said equivalent velocity parameter being determined by an expression
$$\hat{v} = v + \frac{{L}_{c o m}}{( {r}_{c o m} - p ) * m} ,$$
where (r_{com}−p) is a length from said center of mass to said contact point and m is a mass of said robot; and
(c) said control system using said equivalent velocity parameter to determine a necessary center of pressure to stabilize said robot.

7. A method for controlling a humanoid robot as recited in claim 6 wherein said control system determines said angular momentum using a flywheel model comprising a rotating mass allowed to rotate within fixed angular limits.

8. A method for controlling a humanoid robot as recited in claim 6 wherein said control system uses said equivalent velocity parameter in determining where said robot should step.

9. A method for controlling a humanoid robot as recited in claim 7 wherein said control system uses said equivalent velocity parameter in determining where said robot should step.

10. A method for controlling a humanoid robot, said humanoid robot having a control system implemented via software running on a processor, a plurality of sensors providing information to said control system, and a plurality of actuators applying control forces, said robot engaged in a walking motion with a contact point p, said method for control comprising:
(a) said control system determining an angular momentum, L_{com}, for said robot taken at a center of mass for said robot;
(b) said control system determining an equivalent velocity parameter, \hat{ν}, that captures said robot's angular and linear states in a single measure, said equivalent velocity parameter being determined by an expression
$$\hat{v} = v + \frac{{L}_{c o m}}{( {r}_{c o m} - p ) * m} ,$$
where (r_{com}−p) is a length from said center of mass to said contact point and m is a mass of said robot; and
(c) said control system using said equivalent velocity parameter to determine where said robot should step.

11. A method for controlling a humanoid robot as recited in claim 10 wherein said control system determines said angular momentum using a flywheel model comprising a rotating mass allowed to rotate within fixed angular limits.

12. A method for controlling a humanoid robot as recited in claim 10 wherein said control system uses said equivalent velocity parameter in determining a necessary center of pressure to stabilize said robot.
